(19) United States
(12) Patent Application Publication
(10) Pub. No.: US 2003/0199665 A1
(43) Pub. Date: Oct. 23, 2003

(54) PROCESS FOR PRODUCING POLYCARBONATE

(76) Inventors: Takato Kimura, Ichihara City (JP); Satoru Minami, Ichihara City (JP); Tomaki Shimoda, Ichihara City (JP)

Correspondence Address: CANTOR COLBURN, LLP, 55 GRIFFIN ROAD SOUTH, BLOOMFIELD, CT, 06002

(21) Appl. No.: 10/249,318

(22) Filed: Mar. 31, 2003

(30) Foreign Application Priority Data
Apr. 23, 2002 (JP) JP2002-120746

(51) Int. Cl. C08G 64/00

(52) U.S. Cl. 528/196

(57) ABSTRACT

A method for manufacturing polycarbonate comprises: measuring a molar ratio of a carbonic acid diester to a dihydroxy compound in a reactor system using an online analyzer; controlling a supply of at least one of the dihydroxy compound and the carbonic acid diester to the reactor system so that the measured molar ratio is maintained within a selected range; and reacting the dihydroxy compound with the carbonic acid diester to produce the polycarbonate.

### CROSS REFERENCE TO RELATED APPLICATIONS

The present application is a U.S. non-provisional application based upon and claiming priority to Japanese Application No. 2002-120746 filed Apr. 23, 2002, the entire contents of which are hereby incorporated by reference.

### BACKGROUND

This disclosure relates to processes for producing polycarbonate. More specifically, this disclosure relates to processes for producing polycarbonate having a stable melt viscosity during fusion molding.

Aromatic polycarbonate is widely used because of its excellent mechanical properties such as impact resistance, heat resistance, and transparency. Preferred methods for the production of polycarbonate include the interfacial method, wherein phosgene is reacted with an aromatic dihydroxy compound, such as bisphenol A, or the melt transesterification method, wherein a polycondensation reaction occurs between an aromatic dihydroxy compound, such as bisphenol A, and a diphenyl carbonate, such as carbonic acid diester.

Although the former method is more frequently used to manufacture polycarbonate, the latter method does not utilize substances such as phosgene, and hence may be used to prepare polycarbonate more economically. In the polycondensation reaction method, bisphenol A having a melting point of about 156 C and diphenyl carbonate having a melting point of about 80° C. are heated to reach the reaction temperature. A catalyst is added to the reaction mixture followed by polycondensation of the bisphenol A with the diphenyl carbonate to yield polycarbonate.

In order to minimize the variation in the melt viscosity of the polycarbonate produced during the polycondensation reaction, it is desirable to keep the degree of polymerization constant. This is generally achieved by maintaining a constant molar ratio between the carbonic acid diester and the aromatic dihydroxy compound. When the polycondensation reaction is carried out in a batch process, it is generally easy to maintain a constant molar ratio by accurately weighing the amounts of aromatic dihydroxy compound and the carbonic acid diester added to the reactor.

However, in a continuous polymerization process, where the aromatic dihydroxy compound and the carbonic acid diester are continuously supplied to the reactor, it is difficult to control this molar ratio once the ratio has been disturbed. This variation in the molar ratio during the polycondensation reaction results in large variations in the melt viscosity of the polycarbonate.

In the continuous process, the supply of the aromatic dihydroxy compound and the carbonic acid diester to the reactor is generally controlled by flowmeters such as a differential pressure flowmeter, volumetric flowmeter, coriolis flowmeter, electromagnetic flowmeter, and the like. However, since flowmeters are not very precise in their ability to measure flow, it is difficult to maintain a constant molar ratio between the carbonic acid diester and the aromatic dihydroxy compound in the reactor. In order to compensate for the inability to precisely measure the flow rate of the aromatic dihydroxy compound and the carbonic acid diester, the mole ratio between the reactants is generally measured off-line by sampling the reaction mixture at the outlet of the reactor. This result is then used to change the flow rate of the reactants into the reactor in order to maintain the melt viscosity of the polycarbonate as closely as possible.

While the above-mentioned method is generally useful when the rate of polymerization is slow, it is ineffective when the rate of polymerization is increased. Consequently, as the rate of polymerization is increased, control of the molecular weight and hence of the melt viscosity is difficult to attain.

In recent years, polycarbonate has been widely used as a raw material for manufacturing optical storage media such as optical discs or magnetic discs. The molding conditions used for manufacturing these discs is rather severe. In order to produce high-density optical discs, such as digital versatile discs (DVD), in stable manufacturing processes, it is desirable to utilize polycarbonate having a stable melt viscosity with minimal variations in the melt viscosity.

### SUMMARY

A method for manufacturing polycarbonate comprises: measuring a molar ratio of a carbonic acid diester to a dihydroxy compound in a reactor system using an online analyzer; controlling a supply of at least one of the dihydroxy compound and the carbonic acid diester to the reactor system so that the measured molar ratio is maintained within a selected range; and reacting the dihydroxy compound with the carbonic acid diester to produce the polycarbonate.

The above described and other features are exemplified by the following figures and the detailed description.

### DETAILED DESCRIPTION

Disclosed herein is a method for controlling the molecular weight as well as the melt viscosity of the polycarbonate produced in a reaction (e.g., a transesterification reaction), by measuring the molar ratio of carbonic acid diester to aromatic dihydroxy compound online and continuously maintaining this ratio within a selected range during the course of the polycondensation reaction. When the measured molar ratio varies outside the selected range, the rate of flow of the aromatic dihydroxy compound and/or the carbonic acid diester to the reactor is automatically adjusted in order to return the measured molar ratio to within the selected range. This method of conducting the polycondensation reaction permits the production of polycarbonate having a stable melt viscosity.

Further, by utilizing a selected range for the molar ratio of the carbonic acid diester to the aromatic dihydroxy compound, the amount of the end-capping agent used to terminate the polycarbonate may be quickly determined. This method may also be used to manufacture a highly reactive polycarbonate, which may be used as a raw material in the preparation of polymer alloys and copolymers.

Any apparatus that is capable of measuring the molar ratio of carbonic acid diester to aromatic dihydroxy compound directly may be used as an online analyzer. More specifically, online infra-red (e.g., Fourier transfer-infra red (FT-IR)) analysis, near-infra-red (e.g., Fourier transfer near-infra-red (FT-NIR)) analysis, ultra-violet visible (UV-VIS) analysis, spectrophotometric (e.g., Raman spectrophotometric) analysis, liquid chromatography (e.g., high performance liquid chromatography (HPLC)) analysis, gas chromatography mass spectroscopy (GC-MS) analysis, plasma (e.g., inductively coupled plasma (ICP)) analysis, X-ray (e.g., fluorescent X-ray) analysis, differential refractometer analysis, and the like, as well as combinations comprising at least one of the foregoing methods of analysis may be used to determine the molar ratio. The online analyzer is generally installed in the reactor where the aromatic dihydroxy compound and the carbonic acid diester are fed initially and mixed.

It is generally desirable to maintain the molar ratio of the carbonic acid diester to the aromatic dihydroxy compound to be about 0.95 to about 1.20. Within this range it is generally desirable to have the molar ratio greater than or equal to about 1.01. Also desirable within this range is a molar ratio of less than or equal to about 1.10. If the measured ratio deviates from the selected range, the amount of the reactants supplied to the reactor is adjusted so as to return the measured molar ratio to the within the selected range. By controlling the supply of the reactants to the reactor, it is possible to maintain the measured molar ratio of the carbonic acid diester to the aromatic dihydroxy compound within the selected range, and thus control the melt viscosity of the resultant polycarbonate. This permits the manufacture of a consistent quality of polycarbonate. When the measured molar ratio varies outside the selected range, the rate of flow of the reactants to the reactor may generally be automatically adjusted (e.g., by the use of an open-close valve on the raw material supply tank, the raw material liquid distribution pump, and/or elsewhere in the flow path of one or both of the carbonic acid diester and the aromatic dihydroxy compound), to return the measured molar ratio to within the selected range. This is generally achieved by having the output of the on-line measurement analyzer in direct communication with the metering device (e.g., the automatic open-close valve(s), flow controlling device, or the like) so that when the measured molar ratio varies outside the selected range, the metering devices are adjusted to adjust the flow rate of the reactants to the reactor. Alternatively, or in addition, a bypass line having different flow characteristics than a main flow line, may be optionally utilized to supply the reactants from the material supply tank to the reactor, in order to return the measured molar ratio to within the selected range. It is noted that any one of the above mentioned methods of controlling the molar ratio may be used alone or in combination with at least one of the foregoing methods.

Any reactors may be used for the production of polycarbonate having a stable melt viscosity. Either continuous or semi-continuous reactors may be used. Continuous reactors are generally preferred. It is generally desirable to use a reactor having multiple modes of agitation, so that when the viscosity of the reaction mixture is low during the pre-polymerization stage, one mode of agitation is utilized, while another mode of agitation is used during the post-polymerization stage when the viscosity of the reaction mixture is high. Examples of reactors that may be utilized in the production of polycarbonate having a stable melt viscosity include polymerization tank(s) (e.g., a vertical agitation, thin film, vacuum room, flat agitation, and the like), biaxial vent extruder, and the like, as well as combinations comprising at least one of the foregoing reactors. It is generally desirable to use a reactor system having at least two reactors in series, with at least one of the reactors being a vertical agitation polymerization tank.

Some examples of reactor combinations that may be utilized in a reactor system for the production of polycarbonate are a vertical agitation polymerization tank with a flat agitation polymerization tank, flat agitation polymerization tank with a vertical agitation polymerization tank, flat agitation polymerization tank with a flat agitation polymerization tank, vertical agitation polymerization tank with a vacuum room polymerization tank and a flat agitation polymerization tank, and a thin film evaporation polymerization tank with two agitation polymerization tanks, and the like, as well as combinations comprising at least one of the foregoing reactors. By using a reactor system comprising a combination of at least two reactors in series, the polycondensation reactions may be performed efficiently. Furthermore, the method may be adapted to reactions other than the polycondensation reaction, such as solid phase polymerization, vapor phase polymerization, and the like, as well as combinations comprising at least one of the foregoing reaction methods.

It is generally preferred to use a reactor system having a combination of at least three reactors in series, with the combination preferably having at least one flat agitation polymerization tank. Suitable, but non-limiting examples of a reactor system having three reactors are a flat agitation polymerization tank in series with two vertical agitation polymerization tanks, a vertical agitation polymerization tank in series with a thin film evaporation tank and a flat agitation polymerization tank, and a vertical agitation polymerization tank in series with two flat agitation polymerization tanks.

The melt viscosity of polycarbonate is generally represented by the melt flow rate. It is generally desirable for a high viscosity polycarbonate to have a melt flow rate (MFR) of about 1 gram/10 minutes (g/10 min) (e.g., about 0.16 g/10 min when measured at 250° C. and a load of 1.2 kg) to about 70 g/10 min (e.g., about 10.87 g/l 0 min when measured at 250° C. and a load of 1.2 kg) when measured at 300° C. and a load of 1.2 kilograms (kg). Within this range, it is preferable for a high viscosity polycarbonate to have a melt flow rate of greater than or equal to about 2 g/10 min (e.g., about 0.31 g/10 min when measured at 250° C. and a load of 1.2 kg). It is also preferable within this range, is a melt flow rate of less than or equal to about to about 50 g/10 min (e.g., about 7.76 g/10 min when measured at 250° C. and a load of 1.2 kg). For a low viscosity polycarbonate, it is generally desirable to have a melt flow rate of about 5 g/l 0 min to about 20 g/10 min when measured at 250° C. and a load of 1.2 kg. Within this range, it is preferable for a low viscosity polycarbonate to have a melt flow rate of greater than or equal to about 8 g/10 min. It is also preferable, within this range, for a low viscosity polycarbonate to have a melt flow rate of less than or equal to about 16 g/10 min. A desirable variation in melt flow rate of the polycarbonate (whose target melt flow rate is about 10 g/10 min) is about ±2 g/10 min, preferably about ±1 g/10 min, and more preferably about ±0.5 g/10 min, when measured at 300° C. and a load of 1.2 kg; even when measured over a period of greater than or equal to about 15 calendar days, with maintenance of this variation range over a period of greater than or equal to about 30 calendar days more preferred. For a melt flow rate target of about 5 g/10 min, a desired variation in the melt flow rate is about ±1 g/10 min, with about ±0.5 g/10 min preferred, and about ±0.25 g/10 min more preferred, when measured at 300° C. at a load of 1.2 kg.

Generally, a variation in the melt flow rate of less than 20% is readily attained by employing the online control of the molar ratio, even less than or equal to about 10% is readily attained. Preferably, the variation in the melt flow rate is less than or equal to about 5%, with less than or equal to about 3% preferred, less than or equal to about 2% more preferred, and less than or equal to about 1.5% particularly preferred over extended periods of time. The periods of time can be greater than or equal to about 10 calendar days, preferably greater than or equal to about 20 calendar days, and more preferably greater than or equal to about 30 calendar days.

The reactants utilized in the production of the polycarbonate by a polycondensation reaction, are generally a dihydroxy compound and a carbonic acid diester. There is no particular restriction on the type of dihydroxy compound that may be employed. For example, bisphenol compounds represented by the general formula (I) below may be used

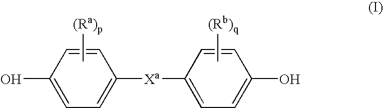

wherein R^{a} and R^{b} may be the same or different and wherein each represents a halogen atom or monovalent hydrocarbon group. p and q are each independently integers from 0 to 4. Preferably, X represents one of the groups of formula (II)

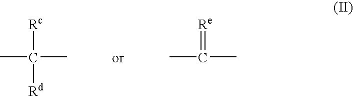

wherein R^{c} and R^{d} each independently represent a hydrogen atom or a monovalent linear or cyclic hydrocarbon group and R^{e} is a divalent hydrocarbon group. Examples of the types of bisphenol compounds that may be represented by formula (I) includes the bis(hydroxyaryl)alkane series such as, 1,1-bis(4-hydroxyphenyl)methane, 1,1-bis (4-hydroxyphenyl)ethane, 2,2-bis(4-hydroxyphenyl)propane (or bisphenol-A), 2,2-bis (4-hydroxyphenyl)butane, 2,2-bis(4-hydroxyphenyl)octane, 1,1-bis(4-hydroxyphenyl) propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl) propane, 2,2-bis(4-hydroxy-3-bromophenyl)propane, and the like; bis(hydroxyaryl) cycloalkane series such as, 1,1-bis(4-hydroxyphenyl)cyclopentane, 1,1-bis(4-hydroxyphenyl)cyclohexane, and the like; and the like, as well as combinations comprising at least one of the foregoing bisphenol compounds.

Other bisphenol compounds that may be represented by formula (I) include those where X is —O—, —S—, —SO— or —SO₂—. Examples of such bisphenol compounds are bis (hydroxyaryl)ethers such as 4,4′-dihydroxy diphenyl ether, and the like; 4,4′-dihydroxy-3,3′-dimethylphenyl ether; bis(hydroxy diaryl)sulfides, such as 4,4′-dihydroxy diphenyl sulfide, 4,4′-dihydroxy-3,3′-dimethyl diphenyl sulfide, and the like; bis(hydroxy diaryl) sulfoxides, such as 4,4′-dihydroxy diphenyl sulfoxides, 4,4′-dihydroxy-3,3′-dimethyl diphenyl sulfoxides, and the like; bis(hydroxy diaryl) sulfones, such as, 4,4′-dihydroxy diphenyl sulfone, 4,4′-dihydroxy-3,3′-dimethyl diphenyl sulfone; and the like, as well as combinations comprising at least one of the foregoing bisphenol compounds.

Other bisphenol compounds that may be utilized in the polycondensation of polycarbonate are represented by the formula (III)

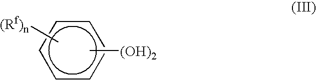

wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (III), are resorcinol, substituted resorcinol compounds (such as 3-methyl resorcin, 3-ethyl resorcin, 3-propyl resorcin, 3-butyl resorcin, 3-t-butyl resorcin, 3-phenyl resorcin, 3-cumyl resorcin, 2,3,4,6-tetrafloro resorcin, 2,3,4,6-tetrabromo resorcin, and the like), catechol, hydroquinone, substituted hydroquinones, (such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, 2,3,5,6-tetramethyl hydroquinone, 2,3,5,6-tetra-t-butyl hydroquinone, 2,3,5,6-tetrafloro hydroquinone, 2,3,5,6-tetrabromo hydroquinone, and the like), and the like, as well as combinations comprising at least one of the foregoing bisphenol compounds.

Bisphenol compounds such as 2,2,2′,2′-tetrahydro-3,3,3′,3′-tetramethyl-1,1′-spirobi-[IH-indene]-6,6′-diol represented by the following formula (IV) may also be used.

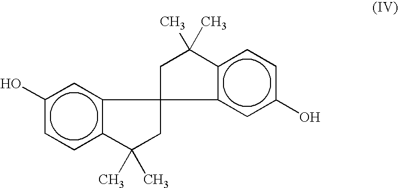

The preferred bisphenol compound is bisphenol A. In addition, copolymeric polycarbonates may be manufactured by reacting at least two or more bisphenol compounds with the carbonic acid diesters. Examples of the carbonic acid diesters that may be utilized to produce the polycarbonates are diphenyl carbonate, bis(2,4-dichlorophenyl)carbonate, bis(2,4,6-trichlorophenyl)carbonate, bis(2-cyanophenyl) carbonate, bis(o-nitrophenyl)carbonate, ditolyl carbonate, m-cresyl carbonate, dinaphthyl carbonate, bis(diphenyl)carbonate, diethyl carbonate, dimethyl carbonate, dibutyl carbonate, dicyclohexyl carbonate, and the like, as well as combinations comprising at least one of the foregoing carbonic acid diesters. The preferred carbonic acid diester is diphenyl carbonate.

Polycarbonate may be obtained, if desired, by the polycondensation of carbonic acid diester containing dicarboxylic acid and/or dicarboxylate ester with the aromatic dihydroxy compound. In general, it is desirable for the carbonic acid diester to contain an amount of less than or equal to about 50 mole percent (mole %), preferably less than or equal to about 30 mole % of either dicarboxylic acid or dicarboxylate ester. Examples of dicarboxylic acids or dicarboxylate esters that may be utilized are terephthalic acid, isophthalic acid, sebacic acid, decanedioic acid, dodecanedioic acid, diphenyl sebacic acid, diphenyl terephthalic acid, diphenyl isophthalic acid, diphenyl decanedioic acid, diphenyl dodecanedioic acid, and the like, as well as combinations comprising at least one of the foregoing. The carbonic acid diester may contain at least two kinds of dicarboxylic acids and/or dicarboxylate esters if desired.

If desired, copolymer polycarbonates may be prepared by reacting a polyfunctional compound having at least three functional groups with the aromatic dihydroxy compound and carbonic acid diester. Suitable polyfunctional compounds are those having a phenolic hydroxy group or a carboxyl group. The preferred polyfunctional compound is a phenolic having three hydroxy groups. Examples of such polyfunctional compounds are 1,1,1-tris(4-hydroxyphenyl)ethane, 2,2′,2″-tris(4-hydroxyphenyl)diisopropyl benzene, α-methyl-α,α′,α′-tris(4-hydroxyphenyl)-1,4-diethyl benzene, α,α′,α″-tris(4-hydroxyphenyl)-1,3,5-triisopropyl benzene, phloroglycine, 4,6-dimethyl-2,4,6-tri(4-hydroxyphenyl)-heptane-2,1,3,5-tri(4-hydroxyphenyl) benzene, 2,2-bis-[4,4-(4,4′-dihydroxyphenyl)-cyclohexyl]-propane, trimellitic acid, 1,3,5-benzene tricarboxylic acid, pyromellitic acid, and the like, as well as combinations comprising at least one of the foregoing polyfunctional compounds. The preferred polyfunctional compounds are 1,1,1-tris(4-hydroxyphenyl) ethane and α,α′,α″-tris(4-hydroxyphenyl)-1,3,5-triisopropyl benzene, or combinations comprising at least one of the foregoing compounds.

Polyfunctional compounds may generally be used in amounts of less than or equal to about 0.03 moles per mole of aromatic dihydroxy compound. Within this range, it is desirable to use the polyfunctional compounds in amounts of greater than or equal to about 0.001 moles per mole of aromatic dihydroxy compound. Also desirable within this range, is an amount of polyfunctional compound of less than or equal to about 0.02 moles, preferably less than or equal to about 0.01 mole per mole of aromatic dihydroxy compound.

During the manufacture of polycarbonates, a chain termination agent may also be used. The chain termination agent used may be an aryloxy compound capable of introducing terminal groups, represented by the general formula (V) below to the end of the manufactured polycarbonate molecules

ArO— (V)

wherein Ar represents an aromatic hydrocarbon group containing 6 to 50 carbon atoms. There is no specific restriction on the type of aromatic hydrocarbon group, which may be a condensed ring structure such as a phenyl group, naphthyl group, anthranyl group, and the like, as well as one of these aromatic rings may form a ring saturated with a hydrocarbon atom(s), a hetero atom and/or different atoms may form cyclic structures. In addition, these aromatic rings may be substituted with a halogen or alkyl group containing 1 to 9 carbon atoms. Examples of aryloxy compounds are phenol, diphenyl carbonate, p-tert-butylphenol, p-tert-butylphenylphenyl carbonate, p-tert-butylphenyl carbonate, p-cumylphenol, p-cumylphenylphenyl carbonate, and the like; chroman compounds such as, 2,2,4-trimethyl-4-(4-hydroxyphenyl) chroman, 2,2,4,6-tetramethyl-4-(3,5-dimethyl-4-hydroxyphenyl) chroman, 2,2,3-trimethyl-3-(4-hydroxyphenyl) chroman, 2,2,3,6-tetramethyl-3-(3,5-dimethyl-4-hydroxyphenyl) chroman, 2,4,4-trimethyl-2-(2-hydroxyphenyl) chroman, and 2,4,4,6-tetramethyl-2-(3,5-dimethyl-2-hydroxyphenyl) chroman, and the like; and the like, as well as combinations comprising at least one of the foregoing aryloxy compounds.

These aryloxy compounds may be present in amounts of about 0.01 moles to about 0.2 moles per mole of the aromatic dihydroxy compound. Within this range it is generally desirable to have the aryloxy compounds in an amount of greater than or equal to about 0.02 moles per mole of the aromatic dihydroxy compound. Also desirable within this range is an amount of less than or equal to about 0.15 moles, and preferably an amount of less than or equal to about 0.1 moles per mole of the aromatic dihydroxy compound.

If the aryloxy compound is used within the above specified amounts as an end capping agent, then the molecular terminals of the polycarbonate that are obtained will be terminated with chain terminating agents expressed by the above-mentioned formula (IV) in an amount of about 1 to about 95%. Within this range, it is desirable to have an amount of greater than or equal to about 10%, preferably greater than or equal to about 20% of the molecular terminals of the polycarbonate terminated with the chain terminating agents. It is also desirable, within this range, to have an amount of less than or equal to about 90% of the molecular terminals of the polycarbonate terminated with the chain terminating agents. A polycarbonate having terminal groups represented by the formula (IV) in the amounts specified by the above-mentioned ranges generally has excellent heat resistance, and also demonstrates excellent mechanical properties such as high impact resistance, even at low molecular weights.

Alternatively or in addition to the above-mentioned aryloxy compounds, one or more aliphatic monocarboxy compounds capable of introducing one or more aliphatic hydrocarbon units represented by the formula (VI) below, may also be introduced as chain terminators,

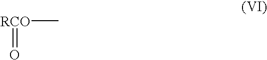

wherein, R represents a straight-chain or branched alkyl group containing 10 to 30 carbon atoms, which may be substituted with a halogen. Examples of the aliphatic monocarboxy compounds are alkyl monocarboxylic acids such as undecanoic acid, lauric acid, tridecanoic acid, pentadecanoic acid, palmitic acid, heptadecanoic acid, stearic acid, nonadecanoic acid, heneicosanoic acid, tricosanoic acid, melissic acid, and the like; methyl stearates, ethyl stearates, phenyl stearates, methyl esters, ethyl esters, and phenyl esters of alkyl monocarboxylic acids, and the like; and the like, as well as combinations comprising at least one of the foregoing aliphatic monocarboxylic compounds.

These types of aliphatic monocarboxy compounds may be used in amounts of about 0.01 to about 0.20 moles per mole of the aromatic dihydroxy compound. Within this range, it is generally desirable to have an amount of greater than or equal to about 0.02 moles per mole of the aromatic dihydroxy compound. Also desirable within this range is an amount of less than or equal to about 0.15 moles, more preferably less than or equal to about 0.10 moles per mole of the aromatic dihydroxy compound. Use of the above types of chain termination agents in total amounts greater than about 0.2 moles per mole of the aromatic dihydroxy compound may reduce the rate of polymerization.

An alkali earth metal compound or an alkaline earth metal compound may be utilized as the catalyst for the polycondensation reaction. Organic salts, inorganic salts, oxides, hydroxides, hydrides and alcoholates of alkali earth metal and/or alkaline earth metal compounds may be utilized to catalyze the polycondensation reaction. Examples of alkali earth metal catalysts are sodium hydroxide, potassium hydroxide, lithium hydroxide, sodium bicarbonate, potassiumbicarbonate, lithium bicarbonate, sodium carbonate, potassium carbonate, lithiumcarbonate, sodium acetate, potassium acetate, lithium acetate, sodium stearate, potassium stearate, lithiumstearate, sodium borohydride, lithium borohydride, sodium boron phenyl, sodium benzoate, potassium benzoate, lithium benzoate, disodium hydrogenphosphate, dipotassium hydrogenphosphate, dilithium hydrogenphosphate, lithium dihydrogenphosphate (LiH₂PO₃), sodium dihydrogenphosphate (NaH₂PO₃), potassium dihydrogenphosphate (KH₂PO₃), rubidium dihydrogenphosphate (RbH₂PO₃), cesium dihydrogenphosphate (CsH₂ PO₃), lithium phosphite (Li₂HPO₃), sodium phosphite (Na₂HPO₃), potassium phosphite (K₂HPO₃), rubidium phosphite (Rb₂HPO₃), cesium phosphite (Cs₂HPO₃), lithium phosphite (Li₃PO₃), sodium phosphite (Na₃PO₃), potassium phosphite (K₃PO₃), rubidium phosphite (Rb₃PO₃), cesium phosphite (Cs₃PO₃), disodium salt, dipotassium salt and dilithium salt of bisphenol A, sodium salt, potassium salt, lithium salt of bisphenol A, and the like, as well as combinations comprising at least one of the foregoing alkali earth metal catalysts. Examples of alkaline earth metal catalysts are calcium hydroxide, barium hydroxide, magnesium hydroxide, strontium hydroxide, calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, strontium stearate, and the like, as well as combinations comprising at least one of the foregoing alkaline earth metal catalysts.

It is generally desirable to utilize an amount of alkali earth metal catalyst of about 1×10⁻⁸ moles to about 1×10⁻³ moles per mole of aromatic dihydroxy compound utilized in the melt polycondensation reaction. Within this range it is generally desirable to have an amount of catalyst greater than or equal to about 1×10⁻⁷ moles per mole of aromatic dihydroxy compound. Also desirable is an amount of less than or equal to about 8×10⁻⁷ moles, and more preferably less than or equal to about 1×10⁻⁶ moles per mole of aromatic dihydroxy compound. Further, if a portion of the alkali earth metal catalyst is added to the dihydroxy compound prior to the reaction, it is desirable to maintain the total amount of catalyst added to the reaction mixture to be within the above desired range.

It may also be desirable to use alkali earth metal compounds in conjunction with basic compounds or an acid (such as boric acid) as catalysts in the polycondensation reaction. Preferred basic compounds that may be used as catalysts are those which contain nitrogen or phosphorus and which decompose at high temperatures. Examples of basic compounds that may be used as catalysts are ammonium hydroxides having alkyl, aryl, araryl, and/or alkaryl groups such as tetramethylammonium hydroxide (Me₄NOH), tetraethylammonium hydroxide (Et₄NOH), tetrabutylammonium hydroxide (Bu₄NOH), and trimethylbenzylammonium hydroxide (φ —CH₂(Me)₃NOH), and the like; phosphonium hydroxides having alkyl, aryl or aralkyl groups such as tetramethylphosphonium hydroxide (Me₄POH), tetraethylphosphonium hydroxide (Et₄POH), tetrabutylphosphonium hydroxide (Bu₄POH), trimethylbenzyl phosphonium hydroxide (φ —CH₂(Me)₃POH), and the like; tertiary amines, such as trimethyl amine, triethyl amine, dimethylbenzyl amine, triphenyl amine, and the like; secondary amines represented by R₂ NH, wherein R may be alkyl, (e.g., methyl, ethyl, and the like) or aryl (e.g., phenyl, toluyl, and the like); primary amines represented by RNH₂ wherein, R may be alkyl, (e.g., methyl, ethyl, and the like) or aryl (e.g., phenyl, toluyl and the like); pyridines, such as 4-dimethylamino pyridine, 4-diethylamino pyridine, 4-pyrolidinopyridine, and the like; imidazole, such as 2-methyl imidazole, 2-phenyl imidazole, and the like; and the like, as well as combinations comprising at least one of the foregoing basic compounds.

Other basic compounds that may be used in addition or alternatively as catalysts are ammonia, tetramethyl ammonium borohydride (Me₄NBH₄), tetrabutyl borohydride (Bu₄NBH₄), tetramethyl ammonium tetraphenyl borate (Me₄NBPh₄), tetrabutyl ammonium tetraphenyl borate (Bu₄NBPh₄), tetramethyl ammonium acetate, tetrabutyl ammonium acetate, tetramethyl ammonium phosphate, tetrabutyl ammonium phosphate, tetramethyl ammonium phosphite, tetrabutyl ammonium phosphite, tetramethyl phosphonium borohydride (Me₄PBH₄), tetrabutyl ammonium phosphonium borohydride (Bu₄PBH₄), tetramethyl phosphonium tetraphenyl borate (Me₄PBPh₄), tetrabutyl phosphonium tetraphenyl borate (Bu₄NBPh₄), tetramethyl phosphonium acetate, tetrabutyl phosphonium acetate, tetramethyl phosphonium phosphate, tetrabutyl phosphonium phosphate, tetramethyl phosphonium phosphite, tetrabutyl phosphonium phosphite, and the like, as well as combinations comprising at least one of the foregoing basic compounds. Preferred basic compounds are tetraalkyl ammonium hydroxide and its salts, and tetraalkyl phosphonium hydroxide and its salts.

The basic compound may be used in an amount of about 1×10⁻⁶ to about 1×10⁻¹ moles per mole of aromatic dihydroxy compound. Within this range it is preferable to use an amount of greater than or equal to about 1×10⁻⁵ molesper mole of aromatic dihydroxy compound. It is also preferable within this range to use an amount of less than or equal to about 1×10⁻² molesper mole of aromatic dihydroxy compound.

The polycondensation reaction between the dihydroxy compound(s) and the carbonic acid diester(s) may be carried out under conditions similar to those for other polycondensation reactions used to produce polycarbonates. Specifically, the dihydroxy compound and the carbonic acid diester may be reacted at atmospheric pressure during the first stage reaction at a temperature of about 80° C. to 250° C. Within this range it is generally desirable to use a temperature of greater than or equal to about 100° C., preferably greater than or equal to about 120° C. Also desirable within this range is a temperature of less than or equal to about 230° C., and preferably less than or equal to about 190° C. It is generally desirable to maintain the reactants in the above mentioned temperature range for up to about 5 hours, preferably for up to about 4 hours, and even more preferably for up to about 3 hours. The reaction temperature is then raised, while the pressure in the reactor is lowered, thus facilitating a reaction between the dihydroxy compound and the carbonic acid diester. The dihydroxy compound and the carbonic acid diester are reacted at temperatures of about 240° C. to about 320° C., under reduced pressures of less than or equal to about 5 millimeters of mercury (mm Hg), preferably less than or equal to about 1 mm Hg. By reacting the aromatic dihydroxy compound and the carbonic acid diester under the aforementioned conditions, a polycarbonate having a stable melt viscosity may be obtained. Furthermore, the automatic control of the measured molar ratio may be used not only to effect control of the mole ratio in the steady state, but may also enable the reaction to be rapidly brought to a steady state after start-up. The polycarbonates produced generally have a stable melt viscosity, and are ideal for a number of applications, including use as general molding materials, as sheets and other construction materials, as headlight lenses for automobiles, as eyeglasses, optical lenses, optical recording materials, and other optical materials, as well as other applications. These polycarbonates are especially ideal for use as an optical molding material.

The following examples, which are meant to be exemplary, not limiting, illustrate compositions and methods of manufacturing of some of the various embodiments of the polycarbonates using various materials and apparatus.

### EXAMPLES

### Example 1

In this example, polycarbonate was polymerized in a reactor system having one agitating tank, two pre-polymerization tanks, two flat agitating polymerization tanks and one twin screw extruder. The agitating tank was used primarily for mixing the bisphenol A and diphenyl carbonate reactants. The reaction conditions for each reactor are shown in Table 1. The melt flow rate was measured in accordance with JIS K-72100 at temperatures of 250° C. and a load of 1.2 kg.

[t1]

TABLE 1

| | Pressure | Temperature | Average retention |
|---|---|---|---|
| Reactor | (torr) | (’ C.) | time (hr) |
| Agitating Tank | Atmospheric | 160 | 2 |
| | pressure | | |
| | (nitrogen | | |
| | atmosphere) | | |
| Pre-polymerization | 100 | 230 | 1 |
| tank I | | | |
| Pre-polymerization | 20 | 240 | 0.5 |
| tank II | | | |
| Flat agitating | 3˜5 | 270 | 0.5 |
| polymerization tank I | | | |
| Flat agitating | 0.1˜1.0 | 275 | 0.5 |
| polymerization tank II | | | |

Molten bisphenol A and diphenyl carbonate obtained directly after distillation were supplied to and mixed in the agitating tank at 160° C., as shown in the Table 1 above. A catalyst composition comprising 0.11 moles (2.5×10⁻⁴ moles/mole of bisphenol A) of tetramethyl ammonium hydroxide and 0.0004 moles (1×10⁻⁶ moles/mole of bisphenol A) sodium hydroxide were added to the reactants and mixed to form a homogeneous mixture. The measured molar ratio of diphenyl carbonate to bisphenol A was continuously monitored using online Fourier transform-near infra-red (FT-NIR) spectroscopy via a spectroscope manufactured by Yokogawa ElectricCorporation and installed in the agitating tank. The measured molar ratio was used to maintain the molar ratio by controlling the rate at which the reactants (i.e., bisphenol A and diphenyl carbonate) were supplied to the reactor.

The polymerization reaction was carried out under thereaction conditions shown in Table 1. The melt flow rate was measured every 2 hours and these results were used to adjust the pressure within the flat agitating polymerization tank I and the flat agitating polymerization tank II so that the melt flow rate of the polycarbonate was adjusted to be about 11.0 g/10 min.

The polycarbonate obtained from the reactors was then mixed with desired additives and extruded to form pellets in atwin screw extruder. The melt flow rate of polycarbonate prepared by the above-mentioned method was recorded for polycarbonate manufactured over a period of one month. As a result of the continuous monitoring of the reaction conditions using the online monitoring equipment, the variance in the melt flow rate of the polycarbonate produced was 10.98±0.16 g/10 min.

### Example 2

Reactants and procedures used in this comparative example were identical with those used in Example 1 above, with the exception that the online FT-NIR monitoring equipment installed in the agitating tank was removed. The melt flow rate of the polycarbonate in the reactor was observed over a period of one month. The variation in the MFR was observed to be 11.12±0.78 g/10 min, which is much larger than that observed in Example 1.

As may be seen from the examples, the polycarbonate produced by the reaction between dihydroxy compound and the carbonic acid diester, while using an online analyzer to monitor the reaction, generally has a variation in the melt flow rate of less than 5%, preferably less than or equal to about 3%, more preferably less than or equal to about 2%, with less than or equal to about 1.5% readily attained even over an extended period of time. These small variations can be maintained for periods of time greater than or equal to about 10 calendar days, preferably greater than or equal to about 20 calendar days, and more preferably greater than or equal to about 30 calendar days. In contrast, in the production of polycarbonate without the use of the analyzer, the percent variation of the molar ratio of the carbonic acid diester to the dihydroxy compound is greater than 7%. Control of the molar ratio enables control of the molecular weight and hence of the melt viscosity in the final product, making a substantial difference in the quality, purity, and usefulness of the final product.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing polycarbonate, comprising:
measuring a molar ratio of a carbonic acid diester to a dihydroxy compound in a reactor system using an online analyzer;
controlling a supply of at least one of the dihydroxy compound and the carbonic acid diester to the reactor system so that the measured molar ratio is maintained within a selected range; and
reacting the dihydroxy compound with the carbonic acid diester to produce the polycarbonate.

2. The method of claim 1, wherein the molar ratio is about 0.95 to about 1.20.

3. The method of claim 2, wherein the molar ratio is about 1.01 to about 1.10.

4. The method of claim 1, wherein the supply of the dihydroxy compound and the carbonic acid diester to the reactor system is controlled by a metering device in operable communication with the online analyzer.

5. The method of claim 4, wherein the metering device comprises an automatic open close valve.

6. The method of claim 1, wherein the reactor system comprises a vertical agitation polymerization tank, a flat agitation polymerization tank, a vacuum room polymerization tank, a thin film evaporation polymerization tank, a twin screw extruder, or a combination comprising at least one of the foregoing reactors.

7. The method of claim 6, wherein the reactor system comprises an agitating tank, a pre-polymerization tank, a flat agitating polymerization tank, and a twin screw extruder.

8. The method of claim 1, wherein the online analyzer comprises an infra-red analyzer, a near-infra-red analyzer, ultra-violet visible analyzer, a spectrophotometric analyzer, a liquid chromatography analyzer, a gas chromatography mass spectroscopy analyzer, a plasma analyzer, a fluorescent X-ray analyzer, a differential refractometer analyzer, or combinations comprising at least one of the foregoing analyzers.

9. The method of claim 8, wherein the analyzer comprises at least one of a Fourier transform-infra-red analyzer and Fourier transform near-infra-red analyzer.

10. The method of claim 1, wherein the dihydroxy compound is bisphenol A and the carbonic acid diester is diphenyl carbonate.

11. The method of claim 1, wherein the polycarbonate produced has a percent variation in a melt flow rate measured at 250° C. at a load of 1.2 kg, of less than 5% for a period of greater than or equal to about 10 calendar days.

12. The method of claim 11, wherein the percent variation is less than or equal to about 3%.

13. The method of claim 12, wherein the period is greater than or equal to about 30 calendar days.

14. The method of claim 12, wherein the percent variation is less than or equal to about 1.5%.

15. The method of claim 1, wherein the polycarbonate produced has a percent variation in a melt flow rate measured at 300° C. at a load of 1.2 kg, of about ±2 g/10 min over a period of greater than or equal to about 15 calendar days.

16. The method of claim 15, wherein the percent variation is about ±1 g/10 min.

17. The method of claim 16, wherein the percent variation is about +0.5 g/10 min.

18. The method of claim 16, wherein the period is greater than or equal to about 30 calendar days.

19. The method of claim 1, wherein the dihydroxy compound comprises an aromatic dihydroxy compound.

20. The method of claim 1, wherein the polycarbonate produced has a percent variation in a melt flow rate of less than 20% for a period of greater than or equal to about 30 calendar days.

21. Polycarbonate formed by the method of claim 12.

22. Polycarbonate formed by the method of claim 18.
